(19) United States
(12) Patent Application Publication
(10) Pub. No.: US 2020/0070469 A1
(43) Pub. Date: Mar. 5, 2020

(54) THERMALLY EXPANDABLE SHEET AND PRODUCTION METHOD FOR SHAPED OBJECT

(71) Applicant: Casio Computer Co., Ltd., Tokyo (JP)

(72) Inventor: Hideki TAKAHASHI, Tokyo (JP)

(21) Appl. No.: 16/552,438

(22) Filed: Aug. 27, 2019

(30) Foreign Application Priority Data
Aug. 31, 2018 (JP) 2018-162825

(51) Int. Cl. B32B 5/20; B32B 27/06; B32B 38/00

(52) U.S. Cl. CPC B32B 5/20; B32B 29/002; B32B 38/145; B32B 27/065

(57) ABSTRACT

A thermally expandable sheet includes a base and a first thermally expansive layer provided on at least a first side of the base and containing a first binder, a first thermally expandable material, and a first electromagnetic wave heat conversion material that converts electromagnetic waves into heat.

### CROSS-REFERENCE TO RELATED APPLICATION

This application claims the benefit of Japanese Patent Application No. 2018-162825, filed on Aug. 31, 2018, the entire disclosure of which is incorporated by reference herein.

### FIELD

The present disclosure relates generally to a thermally expandable sheet that uses a thermally expansive layer including a thermally expandable material that expands according to the amount of heat absorbed, and to a production method for a shaped object that uses the thermally expandable sheet.

### BACKGROUND

In the related art, thermally expandable sheets are known in which a thermally expansive layer containing a thermally expandable material, which foams and distends according to the amount of heat absorbed, is formed on one side of a base sheet. By forming a heat conversion layer that converts light into heat on the thermally expandable sheet and irradiating the heat conversion layer with light, a portion or the entirety of the thermal expansion layer can be caused to distend. Moreover, methods for forming a shape having a stereoscopically uneven surface on the thermally expandable sheet by changing the shape of the heat conversion layer are also known (see, for example, Unexamined Japanese Patent Application Kokai Publication Nos. S64-28660 and 2001-150812).

In the methods described above, a heat conversion layer must be provided on the base or on the thermally expansive layer in order to cause a specific region of the thermally expansive layer to expand. Conventionally, heat conversion layers include carbon black and, consequently, there is a problem of the heat conversion layer being prominent and negatively affecting appearance. There is also a problem of needing a step of forming the heat conversion layer.

Accordingly, there is a demand for a thermally expandable sheet in which the thermally expansive layer can be caused to expand without using a heat conversion layer.

### SUMMARY

According to one aspect of the present disclosure, a thermally expandable sheet includes a base and a first thermally expansive layer provided on at least a first side of the base and containing a first binder, a first thermally expandable material, and a first electromagnetic wave heat conversion material that converts electromagnetic waves into heat.

According to another aspect of the present disclosure, a production method for a shaped object includes preparing a thermally expandable sheet including a base and a first thermally expansive layer provided on at least a first side of the base and containing a first binder, a first thermally expandable material, and a first electromagnetic wave heat conversion material that converts electromagnetic waves into heat, and preparing a mask that includes an opening that corresponds to a region where the first thermally expansive layer is to be caused to distend, irradiating the first thermally expansive layer with electromagnetic waves via the mask, and causing the first thermally expansive layer to distend.

### BRIEF DESCRIPTION OF THE DRAWINGS

A more complete understanding of this application can be obtained when the following detailed description is considered in conjunction with the following drawings, in which:

FIG. 1 is a cross-sectional view illustrating an overview of a thermally expandable sheet according to Embodiment 1;

FIGS. 2A and 2B are cross-sectional views illustrating a production method for the thermally expandable sheet according to Embodiment 1;

FIG. 3 is a cross-sectional view illustrating an overview of a shaped object according to Embodiment 1;

FIGS. 4A and 4B are cross-sectional views illustrating a production method for the shaped object according to Embodiment 1;

FIG. 5 is a cross-sectional view illustrating an overview of a thermally expandable sheet according to Embodiment 2;

FIGS. 6A to 6C are cross-sectional views illustrating a production method for the thermally expandable sheet according to Embodiment 2;

FIG. 7 is a cross-sectional view illustrating an overview of a shaped object according to Embodiment 2;

FIGS. 8A and 8B are cross-sectional views illustrating a production method for the shaped object according to Embodiment 2;

FIG. 9 is a cross-sectional view illustrating an overview of a thermally expandable sheet according to a modified example of Embodiment 2;

FIG. 10 is a cross-sectional view illustrating an overview of a thermally expandable sheet according to Embodiment 3;

FIG. 11A is a cross-sectional view illustrating an overview of a shaped object according to Embodiment 3;

FIG. 11B is a partial cross-sectional view of the shaped object;

FIGS. 12A and 12B are cross-sectional views illustrating a production method for the shaped object according to Embodiment 3;

FIG. 13A is a cross-sectional view illustrating an overview of a thermally expandable sheet according to a Modified Example of Embodiment 3;

FIG. 13B is a cross-sectional view illustrating an overview of a shaped object according to a modified example of Embodiment 3;

FIG. 14A is a cross-sectional view illustrating an overview of a thermally expandable sheet according to Embodiment 4; and FIG. 14B is a cross-sectional view illustrating an overview of a shaped object according to Embodiment 4.

### DETAILED DESCRIPTION

Hereinafter, the drawings are used to describe, in detail, a thermally expandable sheet, a production method for the thermally expandable sheet, and a production method for a shaped object according to embodiments of the present disclosure.

In this application, the term “shaped object” refers to a thermally expandable sheet in which shapes such as simple shapes such as convexities (protrusions) and concavities (recesses), geometrical shapes, characters, patterns, and decorations are shaped (formed) on a predetermined side of the thermally expandable sheet. The term “decorations” refers to objects that appeal to the aesthetic sense through visual and/or tactile sensation. The term “shaped (or formed)” refers to giving shape to an object to form a shaped object, and should be construed to also include concepts such as decorating and ornamenting. The shaped object of the present embodiment is a three-dimensional object that includes unevennesses, geometrical shapes, decorations, or the like on a predetermined side. However, to distinguish this three-dimensional object from three-dimensional objects formed using a so-called 3D printer, the shaped object of the present embodiment is called a 2.5-dimensional (2.5D) object or a pseudo-three-dimensional (pseudo-3D) object. Moreover, the technique used to produce the shaped object of the present embodiment is called 2.5D printing or pseudo-3D printing.

In the present description, for ease of description, the side of the thermally expandable sheet where the thermally expansive layer is provided is referred to as the front side (front surface) or the top surface, and the side of the thermally expandable sheet where the base is provided is referred to as the back side (back surface) or the bottom side. The terms “front”, “back”, “top”, and “bottom” should not be construed to limit the method of use of the thermally expandable sheet. That is, depending on the method of use of the formed thermally expandable sheet, the back side of the thermally expandable sheet can be used as the front side. The same is applicable to the shaped object as well.

### Embodiment 1

Hereinafter, the drawings are used to describe a thermally expandable sheet, a production method for the thermally expandable sheet, and a production method for a shaped object according to Embodiment 1.

Thermally Expandable Sheet 10

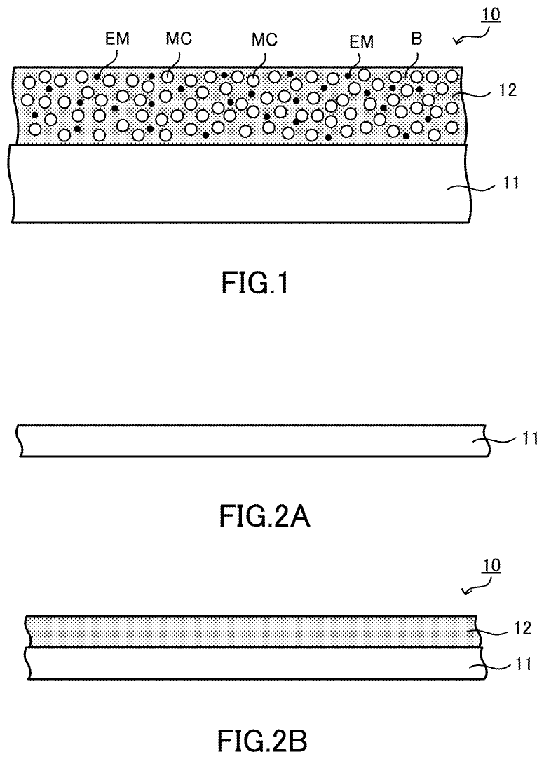

As illustrated in FIG. 1 a thermally expandable sheet 10 includes a base 11 and a thermally expansive layer 12 provided on a first side (the top surface illustrated in FIG. 1) of the base 11.

The base 11 is implemented as a sheet-like member that supports the thermally expansive layer 12. Paper such as high-quality paper and synthetic paper, a sheet made from resin, fabric, and the like, for example, can be used as the base 11. While not limited hereto, examples of the resin include polyolefin resins such as polyethylene (PE) and polypropylene (PP), polyethylene terephthalate (PET), polyethylene naphthalate (PEN), polybutylene terephthalate (PBT), polyester resins, polyamide resins such as nylon, polyvinyl chloride (PVC) resins, polystyrene (PS), polyimide resins, and the like. In one example, the thickness of the base 11 is from 100 to 1000 μm.

The thermally expansive layer 12 is provided on a first side (the top surface in FIG. 1) of the base 11. The thermally expansive layer 12 is a layer that distends to a size that corresponds to the amount of heating (for example, the heating temperature and heating time), and includes a thermally expandable material (thermally expandable microcapsules, micropowder) MC and an electromagnetic wave heat conversion material EM dispersed/disposed in a binder B. The thermally expansive layer 12 is not limited to including one layer and may include a plurality of layers. As described later, the thermally expansive layer 12 is formed on the entire first side of the base 11. However, a configuration is possible in which the thermally expansive layer 12 is not formed on the ends (for example, the margin portions) of the base 11.

Any thermoplastic resin, such as an ethylene-vinyl-acetate polymer or an acrylic polymer, may be used as the binder B of the thermally expansive layer 12. The thermally expandable material MC contains propane, butane, or a similar low boiling point volatile substance in thermoplastic resin shells. The shells are formed from a thermoplastic resin such as, for example, polystyrene, polyvinyl chloride, polyvinylidene chloride, polyvinyl acetate, polyacrylic acid ester, polyacrylonitrile, polybutadiene, or copolymers thereof. In one example, the average particle size of the thermally expandable material MC is about 5 to 50 μm. When the thermally expandable material MC is heated to the thermal expansion start temperature or higher, the shells that are made from the resin soften and the low boiling point volatile substance encapsulated therein vaporizes. The pressure resulting from this vaporization causes the shells to expand in a balloon-like manner. While dependent on the characteristics of the thermally expandable material MC to be used, the particle size of the thermally expandable material MC expands to about five-times larger than the particle size prior to expansion. Note that, while FIG. 1 illustrates the particle size of the thermally expandable material MC as being substantially uniform, there is variation in the particle size of the thermally expandable material MC.

The electromagnetic wave heat conversion material EM (hereinafter referred to as “heat conversion material”) is a material that converts electromagnetic waves into heat. The wavelength of the electromagnetic waves can be set as desired by selecting the device used to emit the electromagnetic waves. In one example, when using a halogen lamp, the wavelength of the electromagnetic waves (light) will be in the near-infrared region (750 to 1400 nm wavelength range), the visible light spectrum (380 to 750 nm wavelength range), or the intermediate infrared region (1400 to 4000 nm wavelength range). Any material capable of effectively converting the emitted electromagnetic waves into heat can be used as the heat conversion material.

Examples of the heat conversion material EM include infrared absorbing agents such as metal oxides, metal borides, and metal nitrides, carbon black, and the like.

Examples of the metal oxides include tungsten oxide compounds, indium oxide, indium tin oxide (ITO), antimony tin oxide (ATO), titanium oxide, zirconium oxide, tantalum oxide, cesium oxide, and zinc oxide.

A metal multiboride compound is preferable and a metal hexaboride compound is particularly preferable as the metal boride, and one or a plurality of materials selected from the group consisting of lanthanum hexaboride (LaB6), cerium hexaboride (CeB6), praseodymium hexaboride (PrB6), neodymium hexaboride (NdB6), gadolinium hexaboride (GdB6), terbium hexaboride (TbB6), tysprosium hexaboride (DyB6), holmium hexaboride (HoB6), yttrium hexaboride (YB6), samarium hexaboride (SmB6), europium hexaboride (EuB6), erbium hexaboride (ErB6), thulium hexaboride (TmB6), ytterbium hexaboride (YbB6), lutetium hexaboride (LuB6), lanthanum hexaboride cerium ((La, Ce)B6), strontium hexaboride (SrB6), calcium hexaboride (CaB6), or the like can be used as the metal boride.

Examples of the metal nitrides include titanium nitride, niobium nitride, tantalum nitride, zirconium nitride, hafnium nitride, and vanadium nitride.

The tungsten oxide compound is expressed by the following formula:

MxWyOz (I)

Here, element M is at least one element selected from the group consisting of Cs, Rb, K, Tl, In, Ba, Li, Ca, Sr, Fe, and Sn, W is tungsten, and O is oxygen.
It is preferable that the value of x/y satisfies the relationship 0.001≤x/y≤1.1, and it is particularly preferable that x/y is in the vicinity of 0.33. Additionally, it is preferable that the value of z/y satisfies the relationship 2.2≤z/y≤3.0. Specific examples of the formula of the tungsten oxide compound include Cs0.33W03, Rb0.33W03, K0.33W03, and Tl0.33W03.

When using a halogen lamp, the heat conversion material EM is preferably a material capable of effectively converting the electromagnetic waves emitted from the halogen lamp into heat. For example, carbon black, the metal hexaboride compound or the tungsten oxide compound is preferable, and the lanthanum hexaboride (LaB6) or cesium tungsten oxide (Cs0.33W03) is particularly preferable from the perspectives of obtaining high light absorptivity (low light transmittance) in the near-infrared region and high transmittance in the visible light spectrum. Lanthanum hexaboride and cesium tungsten oxide have higher transmittance in the visible light spectrum than carbon black. As such, lanthanum hexaboride or cesium tungsten oxide is preferable from the perspective of suppressing the effects of the color of the heat conversion material on the color of the shaped object 51. One materials may be used alone as the heat conversion material EM, or a combination of two or more different materials may be used.

In one example, the content, in the thermally expansive layer 12, of the heat conversion material EM with respect to the total weight of the binder B, the thermally expandable material MC, and the heat conversion material EM is from 5 to 10 wt %. In the present embodiment, heat can be generated in the thermally expansive layer 12 due to the heat conversion material EM being included in the thermally expansive layer 12. As a result, the thermally expansive layer 12 can be caused to distend without using a heat conversion layer.

Production Method for Thermally Expandable Sheet 10

The thermally expandable sheet 10 of the present embodiment is produced as follows. First, as illustrated in FIG. 2A, a sheet-like material such as, for example, a sheet made from high-quality paper, is prepared as the base 11. The base 11 may be in a roll shape or may be precut.

Next, the binder including the thermoplastic resin and the like, the thermally expandable material (the thermally expandable microcapsules), and the heat conversion material are mixed in a solvent. Thus, a coating liquid for forming the thermally expansive layer 12 is prepared. Next, the coating liquid is coated on the first surface of the base 11 using a known coating device such as a bar coater. Next, the solvent is volatilized, thereby forming the thermally expansive layer 12 as illustrated in FIG. 2B. Note that the coating and the drying can be carried out a plurality of times in order to form the thermally expansive layer 12 at the desired thickness. The thermally expansive layer 12 can be formed using a printing device such as a screen printing device. Moreover, in cases in which the base 11 is provided in a roll form, cutting may be performed as desired. Thus, the thermally expandable sheet 10 is produced.

Shaped Object 51

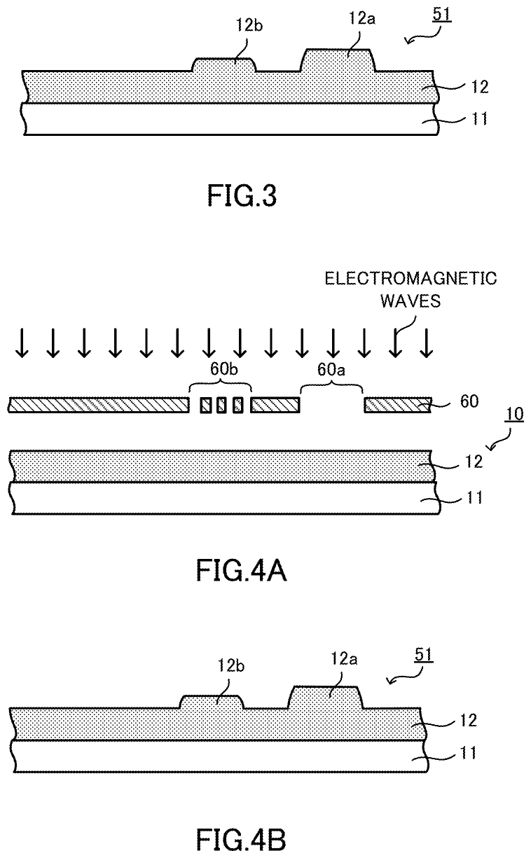

The shaped object 51 is produced using the thermally expandable sheet 10. The shaped object 51 is obtained by at least a portion of the thermally expansive layer 12 of the thermally expandable sheet 10 rising. Specifically, as illustrated in FIG. 3, in the shaped object 51, the thermally expansive layer 12 includes a protrusion 12a and a protrusion 12b that have risen due to the expansion of the thermally expandable material MC. The protrusions 12a and 12b protrude from the surroundings thereof. The shapes of the protrusions 12a and 12b are determined as desired according to the shape to be expressed by the shaped object 51. As described later, the heights of the protrusions 12a and 12b are adjusted by increasing or decreasing the amount of electromagnetic waves to be irradiated on the thermally expansive layer 12.

Production Method for Shaped Object 51

Next, a production method for the shaped object using the thermally expandable sheet 10 will be described using FIGS. 4A and 4B.

First, as illustrated in FIG. 4A, the first side (the top surface in FIG. 4A) of the thermally expandable sheet 10 is irradiated, via a mask 60, with the electromagnetic waves. In this case, a lamp heater such as a halogen lamp is used as the irradiator that emits the electromagnetic waves. The halogen lamp emits electromagnetic waves (light) in the near-infrared region (750 to 1400 nm wavelength range), the visible light spectrum (380 to 750 nm wavelength range), or the intermediate infrared region (1400 to 4000 nm wavelength range). The thermally expandable sheet 10 is irradiated with these electromagnetic waves. Note that the thermally expandable sheet 10 may be irradiated with the electromagnetic waves by transporting the thermally expandable sheet 10 under the irradiator, or the thermally expandable sheet 10 may be irradiated with the electromagnetic waves by moving the irradiator.

Here, the mask 60 is used to cause the electromagnetic waves to selectively reach specific regions of the front side of the thermally expandable sheet 10. The mask 60 includes openings 60a and 60b at positions that correspond to the regions (distension regions) of the thermally expandable sheet 10 where the thermally expansive layer 12 is to be caused to distend. The mask 60 is formed from, for example, a metal such as chrome, stainless steel, or aluminum. Provided that the mask 60 can block the electromagnetic waves, the mask 60 may be formed from a material other than metal.

The planar shapes of the openings 60a and 60b are determined according to the shapes of the protrusions 12a and 12b of the shaped object 51. The opening ratios of the openings 60a and 60b can be changed as desired. In one example, the opening ratio of the opening 60a is set to 100%. Additionally, the opening 60b is formed in a slit shape and the opening ratio is set to a value that is less than 100% (for example, 60%). The electromagnetic waves reach the thermally expandable sheet 10 at the openings 60a and 60b, but are blocked by the mask 60 at the regions other than the openings 60a and 60b. The distension height of the thermally expansive layer 12 is proportional to amount of energy of the electromagnetic waves that are irradiated on the thermally expansive layer 12. Therefore, at the opening 60b, since the opening ratio is reduced, the amount of electromagnetic waves irradiated on the thermally expansive layer 12 is reduced and the distension height of the thermally expansive layer 12 (the height of the protrusion 12b) is reduced. Thus, the distension height of the thermally expansive layer 12 can be adjusted by changing the opening ratio.

In the regions that are irradiated with the electromagnetic waves, the heat conversion material EM in the thermally expansive layer 12 absorbs the electromagnetic waves, thereby generating heat. The thermally expandable material MC in the thermally expansive layer 12 expands when the temperature at which expansion begins is reached due to the generated heat. As illustrated in FIG. 4B, at least a portion of the thermally expansive layer 12 rises due to the expansion of the thermally expandable material MC. Thus, the protrusions 12a and 12b are formed on the thermally expansive layer 12, and the shaped object 51 is produced.

According to the present embodiment, the thermally expansive layer 12 of the thermally expandable sheet 10 includes the heat conversion material EM and, as a result, specific regions of the thermally expansive layer 12 can be selectively caused to distend by irradiating, via the mask 60, the thermally expansive layer 12 with the electromagnetic waves. Thus, by using the thermally expandable sheet 10 of the present embodiment, it is possible to cause the thermally expansive layer 12 to distend and produce the shaped object 51 without using a heat conversion layer, which is typically required.

### Embodiment 2

Hereinafter, the drawings are used to describe a thermally expandable sheet 20 according to Embodiment 2. The thermally expandable sheet 20 according to the present embodiment differs from the thermally expandable sheet 10 according to Embodiment 1 in that the thermally expansive layer 21 is patterned. Constituents that are the same as those described in Embodiment 1 are marked with the same reference numerals and detailed descriptions thereof are forgone.

Thermally Expandable Sheet 20

The thermally expandable sheet 20 includes a base 11 and a thermally expansive layer 21. The base 11 is the same as in Embodiment 1.

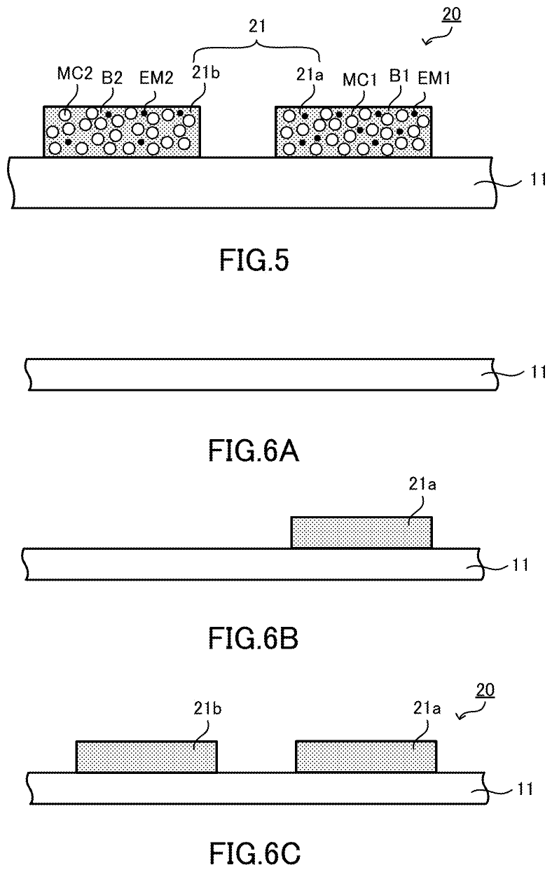

The thermally expansive layer 21 is provided on at least a portion of the region of a first side (the top surface illustrated in FIG. 5) of the base 11. The thermally expansive layer 21 is patterned and is formed in a desired shape. In one example, as illustrated in FIG. 5, the thermally expansive layer 21 includes a first thermally expansive layer 21a and a second thermally expansive layer 21b on the first side of the base 11. As with the thermally expansive layer 12 of Embodiment 1, the thermally expansive layer 21 is a layer that distends to a size that corresponds to the amount of heating.

The first thermally expansive layer 21a includes a binder B1, a thermally expandable material MC1, and a heat conversion material EM1. The binder B1, the thermally expandable material MC1, and the heat conversion material EM1 are the same as in Embodiment 1. The first thermally expansive layer 21a includes the heat conversion material EM1 at a first ratio (for example, in wt %) with respect to the total weight of the binder B1, the thermally expandable material MC1, and the heat conversion material EM1.

The second thermally expansive layer 21b is provided on the first side of the base 11, in a region that differs from the first thermally expansive layer 21a. The second thermally expansive layer 21b includes a binder B2, a thermally expandable material MC2, and a heat conversion material EM2. The second thermally expansive layer 21b includes the heat conversion material EM2 at a second ratio (for example, in wt %) with respect to the total weight of the binder B2, the thermally expandable material MC2, and the heat conversion material EM2.

The first ratio and the second ratio may be the same or different. In the present embodiment, an example of a configuration is described in which the first ratio of the first thermally expansive layer 21a is greater than the second ratio of the second thermally expansive layer 21b. The heat generated in the thermally expansive layer 21 can be increased by increasing the ratio of the heat conversion material EM included in the thermally expansive layer 21. Accordingly, when irradiated by the electromagnetic waves under the same conditions, the first thermally expansive layer 21a can be caused to rise higher than the second thermally expansive layer 21b. Note that, the thickness of the first thermally expansive layer 21a and the thickness of the second thermally expansive layer 21b may be the same as illustrated in the drawings, or may be different. Moreover, while configurations are possible in which at least portions of the first thermally expansive layer 21a and the second thermally expansive layer 21b are formed from different materials, from the perspective of reducing costs, it is preferable that the first thermally expansive layer 21a and the second thermally expansive layer 21b are formed using the same material.

Production Method for Thermally Expandable Sheet 20

The thermally expandable sheet 20 of the present embodiment is produced as follows. First, as illustrated in FIG. 6A, a sheet-like material such as, for example, a sheet made from high-quality paper, is prepared as the base 11. The base 11 may be in a roll shape or may be precut.

Next, the binder B1 including the thermoplastic resin and the like, the thermally expandable material MC1, and the heat conversion material EM1 are mixed in a solvent. Thus, an ink for forming the first thermally expansive layer 21a is prepared. In the ink, the heat conversion material EM1 is mixed at a first ratio (for example, in wt %) with respect to the total weight of the binder B1, the thermally expandable material MC1, and the heat conversion material EM1. Next, the ink is printed on the first side of the base 11 by a printing device such as a screen printing device. The ink is printed in a pattern that corresponds to the first thermally expansive layer 21a. Next, the solvent is volatilized, thereby forming the first thermally expansive layer 21a as illustrated in FIG. 6B. Note that the printing and the drying can be carried out a plurality of times in order to form the first thermally expansive layer 21a at the desired thickness.

Next, the binder B2 including the thermoplastic resin and the like, the thermally expandable material MC2, and the heat conversion material EM2 are mixed in a solvent. Thus, an ink for forming the second thermally expansive layer 21b is prepared. In the ink, the heat conversion material EM2 is mixed at a second ratio (for example, in wt %) with respect to the total weight of the binder B2, the thermally expandable material MC2, and the heat conversion material EM2. The second ratio is less than the first ratio. Next, the ink is printed on the first side of the base 11 by a printing device such as a screen printing device. The ink is printed in a pattern that corresponds to the second thermally expansive layer 21b. Next, the solvent is volatilized, thereby forming the second thermally expansive layer 21b as illustrated in FIG. 6C. Note that the printing and the drying can be carried out a plurality of times. Moreover, in cases in which the base 11 is provided in a roll form, cutting may be performed as desired. Thus, the thermally expandable sheet 20 is produced.

In cases in which the ratio of the heat conversion material EM1 included in the first thermally expansive layer 21a and the ratio of the heat conversion material EM2 included in the second thermally expansive layer 21b are the same, the first thermally expansive layer 21a and the second thermally expansive layer 21b may be formed simultaneously.

Shaped Object 52

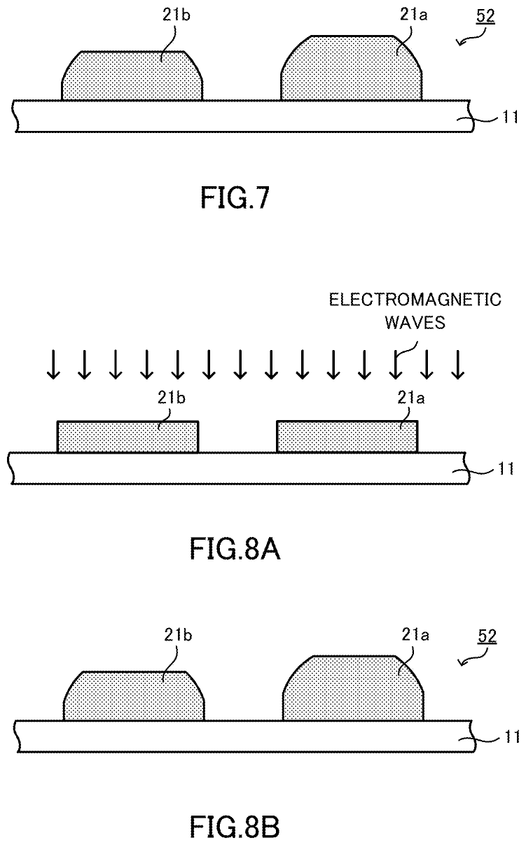

The shaped object 52 is produced using the thermally expandable sheet 20. The shaped object 52 is obtained by the thermally expansive layer 21 rising. Specifically, as illustrated in FIG. 7, in the shaped object 52, the thermally expansive layer 21 includes the first thermally expansive layer 21a that has risen due to the expansion of the thermally expandable material MC1 and the second thermally expansive layer 21b that has risen due to the expansion of the thermally expandable material MC2. Since the content of the first thermally expansive layer 21a contains the heat conversion material EM1 at a higher ratio than the second thermally expansive layer 21b, the height of the first thermally expansive layer 21a after distension is greater than the height of the second thermally expansive layer 21b after distension.

Production Method for Shaped Object 52

Next, a production method for the shaped object 52 using the thermally expandable sheet 20 will be described using FIGS. 8A and 8B.

As in Embodiment 1, in the present embodiment, the first side (the top surface in FIG. 8A) of the thermally expandable sheet 20 is irradiated with electromagnetic waves using a halogen lamp. In the present embodiment, the mask 60 is not used, and the first side (for example, the entire first side) of the thermally expandable sheet 20 is irradiated with the electromagnetic waves.

When irradiated with the electromagnetic waves, the heat conversion material EM1 in the first thermally expansive layer 21a and the heat conversion material EM2 in the second thermally expansive layer 21b absorb the electromagnetic waves, thereby generating heat. The thermally expandable material MC1 in the first thermally expansive layer 21a expands when the temperature at which expansion begins is reached due to the generated heat. Likewise, the second thermally expandable material MC2 in the thermally expansive layer 21b expands. In the present embodiment, the ratio at which the heat conversion material EM1 is included in the first thermally expansive layer 21a is set higher than the ratio at which the heat conversion material EM2 is included in the second thermally expansive layer 21b. As a result, more heat is generated in the first thermally expansive layer 21a and, as illustrated in FIG. 8B, the first thermally expansive layer 21a rises higher than the second thermally expansive layer 21b. Thus, the shaped object 52 is produced.

According to the present embodiment, the thermally expansive layer 21 of the thermally expandable sheet 20 includes the heat conversion material and, as such, it is possible to cause the thermally expansive layer 21 to distend without using a heat conversion layer, which is typically required. Additionally, in the present embodiment, the thermally expansive layer 21 itself is patterned and formed into a desired shape. As a result of this configuration, the entire thermally expansive layer 21 can be irradiated with the electromagnetic waves and the thermally expansive layer 21 provided in specific regions can be caused to distend. Moreover, the thermally expansive layer 21 includes the first thermally expansive layer 21a and the second thermally expansive layer 21b, and the ratios at which the heat conversion materials are included are different. As a result of this configuration, the heights of the first thermally expansive layer 21a and the second thermally expansive layer 21b after distention can be made different.

In Embodiment 2 described above, an example of a configuration is described in which the first thermally expansive layer 21a and the second thermally expansive layer 21b are separated from each other, but a configuration is possible in which the first thermally expansive layer 21a and the second thermally expansive layer 21b contact each other. Furthermore, a configuration is possible in which the thermally expandable sheet 20 further includes one or more separate thermally expansive layers (not illustrated in the drawings) in regions that differ from the regions where the first thermally expansive layer 21a and the second thermally expansive layer 21b are provided. In this case as well, the ratio at which the heat conversion material is included may differ for each of the thermally expansive layers.

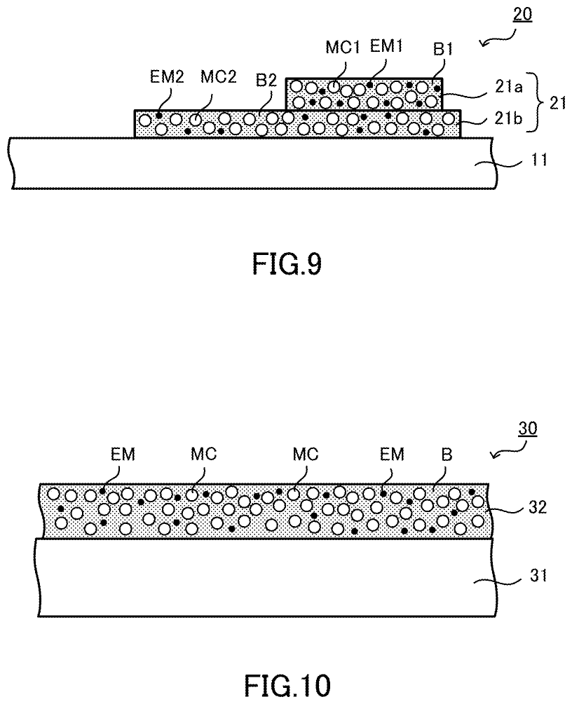

In Embodiment 2 described above, an example of a configuration is described in which the first thermally expansive layer 21a and the second thermally expansive layer 21b are disposed juxtaposed on the first side of the base 11, but a configuration is possible in which at least a portion of the first thermally expansive layer 21a and the second thermally expansive layer 21b overlap each other. For example, as illustrated in FIG. 9, a configuration is possible in which the second thermally expansive layer 21b is provided on the first side of the base 11 and the first thermally expansive layer 21a is laminated on the second thermally expansive layer 21b. In this case as well, the ratio at which the heat conversion material is included in the first thermally expansive layer 21a and the second thermally expansive layer 21b may be the same or different. Moreover, a configuration is possible in one or more separate thermally expansive layers are provided on the second thermally expansive layer 21b or on the thermally expansive layer 21a, or in regions that differ from the region where the second thermally expansive layer 21b is provided. In this case as well, the ratio, thickness, and the like at which the heat conversion material is included may differ for each of the thermally expansive layers.

### Embodiment 3

Hereinafter, the drawings are used to describe a thermally expandable sheet 30 according to Embodiment 3. The thermally expandable sheet 30 according to the present embodiment differs from the thermally expandable sheet 10 according to Embodiment 1 in that the base deforms due to the distending of the thermally expansive layer. Constituents that are the same as those described in Embodiment 1 and the like are marked with the same reference numerals and detailed descriptions thereof are forgone.

Thermally Expandable Sheet 30

As illustrated in FIG. 10, the thermally expandable sheet 30 of the present embodiment includes a base 31 and a thermally expansive layer 32 provided on a first surface of the base 31.

The base 31 is implemented as a sheet-like member that supports the thermally expansive layer 32. In the present embodiment, since at least a portion of the base 31 deforms, a sheet made from resin is used as the base 31. While not limited hereto, examples of the resin include polyolefin resins such as polyethylene (PE) and polypropylene (PP), polyethylene terephthalate (PET), polyethylene naphthalate (PEN), polybutylene terephthalate (PBT), polyester resins, polyamide resins such as nylon, polyvinyl chloride (PVC) resins, polystyrene (PS), polyimide resins, and the like.

The base 31 may be made to be easily deformable by heat. As such, the material used as the base 31, the thickness of the base 31, and the like are determined such that the base 31 is easily deformed by heat and the shape after deformation can be maintained. The material, the thickness, and the like of the base 31 may be designed so as to be suited to the application of the produced shaped object 53. For example, depending on the application of the shaped object 53, there are cases in which, instead of simply maintaining the deformed shape, the shaped object 53 must have elastic force that allows the shaped object 53 to return to the original shape after having been pressed and deformed. In such a case, the material of the base 31 is determined so as to provide the deformed base 31 with the required elastic force. Moreover, while not limited hereto, the base 31 has a thickness of 100 to 500 μm.

The thermally expansive layer 32 is provided on the first side (the top surface illustrated in FIG. 10) of the base 31. The thermally expansive layer 32 is the same as the thermally expansive layer 12 described in Embodiment 1, and is a layer that distends to a size that corresponds to the amount of heating. Additionally, the thermally expansive layer 32 includes a thermally expandable material MC and an electromagnetic wave heat conversion material EM dispersed/disposed in a binder B. The thermally expansive layer 32 is not limited to including one layer and may include a plurality of layers. As described later, the thermally expansive layer 32 is formed on the entire first side of the base 31. However, a configuration is possible in which the thermally expansive layer 32 is not formed on the ends, such as the margins, of the base 31. The binder B, the thermally expandable material MC, and the heat conversion material EM are the same as in Embodiment 1.

In the present embodiment, it is sufficient that the thermally expansive layer 32 has at least a thickness that allows the base 31 to be deformed into the desired shape. Therefore, the thermally expansive layer 32 may be formed with the same or a thinner thickness than the base 31. As a result, compared to Embodiment 1, the material used to form the thermally expansive layer 32 can be reduced and costs can be reduced.

Production Method for Thermally Expandable Sheet 30

The production method for the thermally expandable sheet 30 is the same as the production method described in Embodiment 1. First, a sheet-like material is prepared as the base 31. At this time, in the present embodiment, a sheet made from resin that is deformable by the thermally expansive layer 32 is prepared. In one example, non-oriented PET or the like is used. Next, the binder including the thermoplastic resin and the like, the thermally expandable material, and the heat conversion material are mixed in a solvent. Thus, a coating liquid for forming the thermally expansive layer 32 is prepared. The coating liquid is coated on the first surface of the base 31 using a known coating device such as a bar coater or a printing device such as a screen printing device. Next, the solvent is volatilized, thereby forming the thermally expansive layer 32. Thus, the thermally expandable sheet 30 is produced.

Shaped Object 53

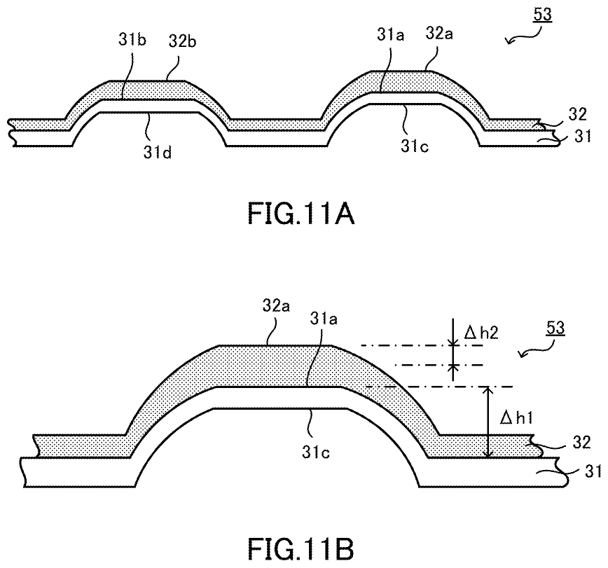

Next, FIGS. 11A and 11B are used to describe the shaped object 53. As with the shaped object 51 of Embodiment 1, the shaped object 53 is produced by causing the thermally expansive layer 32 of the thermally expandable sheet 30 to distend. However, the shaped object 53 of the present embodiment differs in that the base 31 is deformed.

As illustrated in FIG. 11A, in the shaped object 53, the thermally expansive layer 32 includes protrusions 32a and 32b that have risen due to the expansion of the thermally expandable material MC. The protrusion 32a and the protrusion 32b protrude from the surrounding regions. The base 31 includes, under the protrusion 32a of the thermally expansive layer 32, a protrusion 31a that deformed with the distension of the protrusion 32a. Additionally, the base 31 includes, under the protrusion 32b of the thermally expansive layer 32, a protrusion 31b that deformed with the distension of the protrusion 32b. Furthermore, the base 31 includes a recess 31c that has a shape that corresponds to the protrusion 31a, and a recess 31d that has a shape that corresponds to the protrusion 31b. In the present description, the shapes of the protrusion 32a of the thermally expansive layer 32, and the protrusion 31a and the recess 31c of the base 31 are expressed as embossed shapes. The same is true for the protrusion 32b and the protrusion 31b and the recess 31d of the base 31.

With the thermally expandable sheet 30 of the present embodiment, since the base 31 is deformed using the thermally expansive layer 32, an amount of deformation Δh1 of the base 31 may be greater than a foaming height Δh2 of the thermally expansive layer 32, as illustrated in FIG. 11B. Note that the amount of deformation Δh1 is the height of the protrusion 31a measured from the surface of a non-deformed region of the base 31. The foaming height (difference) Δh2 of the thermally expansive layer 32 is obtained by subtracting the height of the thermally expansive layer 32 before distension from the height of the thermally expansive layer 32 after distension. The difference Δh2 can also be described as the amount of increase in height of the thermally expansive layer 32, caused by the expansion of the thermally expandable material. The same is true for the amount of deformation of the protrusion 31b and the foaming height of the protrusion 32b.

Production Method for Shaped Object 53

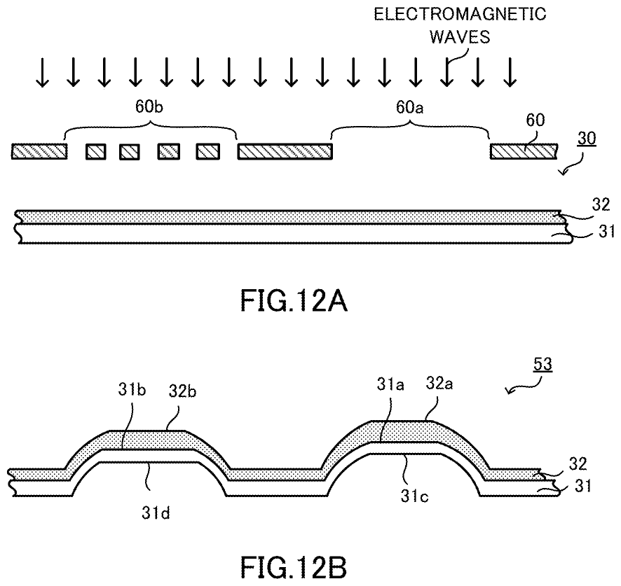

Next, a production method for the shaped object 53 using the thermally expandable sheet 30 will be described using FIGS. 12A and 12B.

First, as illustrated in FIG. 12A, the first side (the top surface in FIG. 12A) of the thermally expandable sheet 30 is irradiated, via a mask 60, with the electromagnetic waves. In this case, as in Embodiment 1, a halogen lamp, for example, is used as the irradiator that emits the electromagnetic waves. As in Embodiment 1, the mask 60 includes openings 60a and 60b at positions that correspond to the regions (distension regions) of the thermally expandable sheet 30 that is to be caused to distend. As a result, only specific regions of the thermally expansive layer 32 of the thermally expandable sheet 30 can be selectively caused to distend. In the present embodiment, the planar shape of the openings 60a and 60b can be determined according to the shape of the shaped object 53, and the opening ratios of the openings 60a and 60b can be changed as desired. For example, by setting the opening ratio of the opening 60b lower than the opening ratio of the opening 60a, the amount of energy of the electromagnetic waves irradiated on the thermally expansive layer 32 can reduced and the distension height of the or the protrusion 32b of the thermally expansive layer 32 can be reduced. As a result, the height of the protrusion 31b of the base 11 that deforms with the protrusion 32b can also be reduced.

In the regions that are irradiated with the electromagnetic waves, the heat conversion material EM in the thermally expansive layer 32 absorbs the electromagnetic waves, thereby generating heat. The heat generated in the thermally expansive layer 32 may transfer to the base 31 and soften the base 31. The thermally expandable material MC in the thermally expansive layer 32 expands when the temperature at which expansion begins is reached. Next, as illustrated in FIG. 12B, at least a portion of the thermally expansive layer 32 rises due to the expansion of the thermally expandable material MC, and the base 31 deforms due to the rising of the thermally expansive layer 32. As a result, the protrusions 32a and 32b are formed on the thermally expansive layer 32, and the protrusions 31a and 31b and the recesses 31c and 31d are formed on the base 31. Thus, the shaped object 53 is produced.

According to the present embodiment, the thermally expansive layer 32 of the thermally expandable sheet 30 includes the heat conversion material EM and, as a result, specific regions of the thermally expansive layer 32 can be selectively caused to distend by irradiating, via the mask 60, the thermally expansive layer 32 with the electromagnetic waves. Furthermore, the distending force of the thermally expansive layer 32 can be used to cause the base 31 to deform. Thus, by using the thermally expandable sheet 30 of the present embodiment, it is possible to cause the thermally expansive layer 32 to distend and produce a shaped object 53 in which the base 31 is deformed, without using a heat conversion layer, which is typically required.

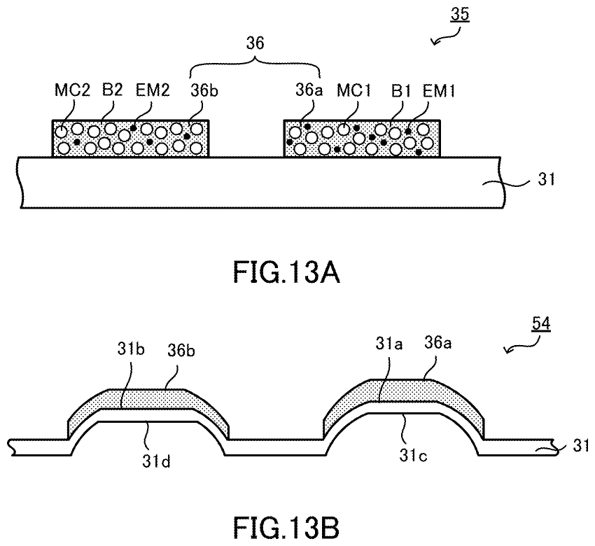

In Embodiment 3, as in Embodiment 2, it is possible to pattern the thermally expansive layer that includes the heat conversion material and irradiate the entire thermally expansive layer 32 with the electromagnetic waves without using the mask 60. In such a case, as illustrated in FIG. 13A, a thermally expandable sheet 35 includes a thermally expansive layer 36 on a first side (the top surface illustrated in FIG. 13A) of the base 31. The thermally expansive layer 36 includes a first thermally expansive layer 36a and a second thermally expansive layer 36b.

As in Embodiment 2, the first thermally expansive layer 36a includes the heat conversion material EM1 at a first ratio (for example, in wt %) with respect to the total weight of the binder B1, the thermally expandable material MC1, and the heat conversion material EM1. The second thermally expansive layer 36b includes a binder B2, a thermally expandable material MC2, and a heat conversion material EM2. The second thermally expansive layer 36b includes the heat conversion material EM2 at a second ratio (for example, in wt %) with respect to the total weight of the binder B2, the thermally expandable material MC2, and the heat conversion material EM2. The first ratio and the second ratio may be the same or different. In the present embodiment, an example of a configuration is described in which the first ratio is greater than the second ratio. Additionally, the thickness of the first thermally expansive layer 36a and the thickness of the second thermally expansive layer 36b may be the same as illustrated in the drawings, or may be different.

FIG. 13B illustrates a shaped object 54 formed by irradiating the thermally expandable sheet 35 illustrated in FIG. 13A with the electromagnetic waves, and causing the thermally expansive layer 36 to distend. As illustrated in FIG. 13B, in the shaped object 54, the first thermally expansive layer 36a and the second thermally expansive layer 36b rise due to the expansion of the thermally expandable material MC. Additionally, the base 31 deforms with the distension of the thermally expansive layer 36. Thus, the protrusions 31a and 31b and the recesses 31c and 31d are formed on the base 31, and the shaped object 54 is produced.

### Embodiment 4

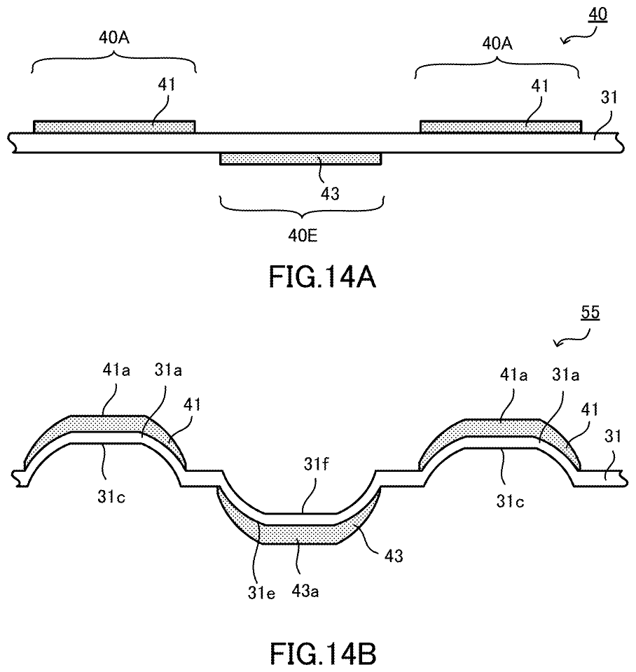

Next, FIGS. 14A and 14B are used to describe a thermally expandable sheet 40 according to Embodiment 4. The present embodiment includes a feature of a third thermally expansive layer 43 that is provided on a second side of the base 31. Detailed descriptions of constituents that are the same as those described in the preceding embodiments are forgone.

Thermally Expandable Sheet 40

As illustrated in FIG. 14A, the thermally expandable sheet 40 includes a base 31, a first thermally expansive layer 41 and a third thermally expansive layer 43. The base 31 is the same as in Embodiment 3.

The first thermally expansive layer 41 is the same as in the embodiments described above, and is a layer that distends to a size that corresponds to the amount of heating. Additionally, the first thermally expansive layer 41 includes a thermally expandable material and a heat conversion material dispersed/disposed in a binder. Note that, in FIG. 14A, the binder, the thermally expandable material, and the heat conversion material are not illustrated. The binder, the thermally expandable material, and the heat conversion material are the same as in the embodiments described above. The first thermally expansive layer 41 is provided on the first side (the top surface illustrated in FIG. 14A) of the base 31. The first thermally expansive layer 41 is used to form a protrusion 31a on the first side of the base 31. Therefore, the first thermally expansive layer 41 is provided on the base 31, in a region (a first region 40A) where the protrusion 31a is to be formed.

Like the first thermally expansive layer 41, the third thermally expansive layer 43 is a layer that distends to a size that corresponds to the amount of heating. Additionally, the third thermally expansive layer 43 includes a thermally expandable material and a heat conversion material dispersed/disposed in a binder. The third thermally expansive layer 43 is provided on the second side (the side opposite the first side, the bottom surface illustrated in FIG. 14A) of the base 31. The third thermally expansive layer 43 is used to form a protrusion 31e on the second side of the base 31. Therefore, the third thermally expansive layer 43 is provided on the base 31, in a region (a second region 40E) where the protrusion 31e is to be formed.

In order to effectively cause the base 31 to deform, is preferable that the deformation of the base 31 is not obstructed, in the region where the base 31 is to be caused to deform using one of the first thermally expansive layer 41 and the third thermally expansive layer 43, by the other of the first thermally expansive layer 41 and the third thermally expansive layer 43. Accordingly, it is preferable that the third thermally expansive layer 43 not be provided on the second side of the base 31 in the region of the base 31 that is to be caused to deform by the first thermally expansive layer 41 (the first region 40A illustrated in FIG. 14A). Likewise, it is preferable that the first thermally expansive layer 41 not be provided on the first side of the base 31 in the region of the base 31 that is to be caused to deform by the third thermally expansive layer 43 (the second region 40E illustrated in FIG. 14A). As such, it is preferable that the first region 40A and the second region 40E are provided so as not to overlap each other. In other words, the first region 40A and the second region 40E are provided so as not to be opposite each other across the base 31.

Production Method for Thermally Expandable Sheet 40

The thermally expandable sheet 40 of the present embodiment is produced as follows. First, as in Embodiment 3, a sheet-like material such as, for example, a sheet made from non-oriented PET, is prepared as the base 31.

Next, the binder, the thermally expandable material, and the heat conversion material are mixed, thereby preparing an ink for forming the first thermally expansive layer 41. This ink is applied, in a pattern that corresponds to the first thermally expansive layer 41, on the first side of the base using a desired printing device such as a screen printing device. Next, the solvent is volatilized, thereby forming the first thermally expansive layer 41.

Next, the binder, the thermally expandable material, and the heat conversion material are mixed, thereby preparing an ink for forming the third thermally expansive layer 43. Using this ink, the third thermally expansive layer 43 is formed on the second side of the base 31 by a screen printing device or the like. Note that the third thermally expansive layer 43 may be formed using the same ink used to form the first thermally expansive layer 41. Moreover, cutting may be performed as desired. Thus, the thermally expandable sheet 40 is produced.

Shaped Object 55

Next, the drawings are used to describe a shaped object 55. The shaped object 55 is produced by causing the first thermally expansive layer 41 and the third thermally expansive layer 43 to distend. In the shaped object 55, as illustrated in FIG. 14B, the thermally expansive layer 41 includes a protrusion 41a on the top surface thereof and, as illustrated in FIG. 14B, the third thermally expansive layer 43 includes a protrusion 43a that protrudes downward. The base 31 includes, on the first side, a protrusion 31a that deformed with the distension of the first thermally expansive layer 41. Likewise, the base 31 includes, on the second side, a protrusion 31e that deformed with the distension of the third thermally expansive layer 43. Furthermore, the base 31 includes a recess 31c that has a shape that corresponds to the protrusion 31a, and a recess 31f that has a shape that corresponds to the protrusion 31e.

As with Embodiment 3, with the shaped object 55 of the present embodiment as well, the amount of deformation of the base 31 may be greater than the foaming height of the first thermally expansive layer 41. The same is applicable to the third thermally expansive layer 43 as well.

Production Method for Shaped Object 55

Next, a production method for the shaped object 55 using the thermally expandable sheet 40 of the present embodiment will be described.

As in Embodiment 2, in the present embodiment, the first side (the top surface in FIG. 14A) of the thermally expandable sheet 40 is irradiated with electromagnetic waves using a halogen lamp. In the present embodiment, the mask 60 is not used, and the entire first side of the thermally expandable sheet 40 is irradiated with the electromagnetic waves.

When irradiated with the electromagnetic waves, the heat conversion material in the first thermally expansive layer 41 absorbs the electromagnetic waves, thereby generating heat. The thermally expandable material in the first thermally expansive layer 41 expands when the temperature at which expansion begins is reached due to the generated heat. The heat generated in the first thermally expansive layer 41 may transfer to the base 31 and soften the base 31. As a result, the region of the thermally expandable sheet 40 where the first thermally expansive layer 41 is provided distends and rises. The base 31 is deformed by being pulled by the distending force of the first thermally expansive layer 41. As a result, the protrusion 31a and the recess 31c are formed.

The electromagnetic waves that the first side of the base 31 is irradiated with also reach the second side of the base 31. As a result, the heat conversion material in the third thermally expansive layer 43 also absorbs the electromagnetic waves and generates heat. The thermally expandable material in the third thermally expansive layer 43 expands due to the generated heat. Additionally, the base 31 may soften. As a result, the region of the thermally expandable sheet 40 where the third thermally expansive layer 43 is provided distends and rises, and the base 31 deforms by being pulled by the distending force of the third thermally expansive layer 43. As a result, the protrusion 31e and the recess 31f are formed. Thus, the shaped object 55 is produced.

Note that, when one side of the thermally expandable sheet 40 is irradiated with the electromagnetic waves and the first thermally expansive layer 41 and the third thermally expansive layer 43 are to be caused to distend in the same process, it is preferable that a transparent base be used as the base 31. Additionally, the electromagnetic waves may be irradiated from the second side (the bottom surface illustrated in FIG. 14B) of the thermally expandable sheet 40.

According to the present embodiment, the first thermally expansive layer 41 and the third thermally expansive layer 43 of the thermally expandable sheet 40 include the heat conversion material and, as a result, the first thermally expansive layer 41 and the third thermally expansive layer 43 can be caused to distend by irradiating the thermally expandable sheet 40 with the electromagnetic waves. Furthermore, the distending forces of the first thermally expansive layer 41 and the third thermally expansive layer 43 can be used to cause the base 31 to deform. In particular, in the present embodiment, the protrusions 31a and 31e that protrude from the surroundings can be formed on the first side and the second side of the base 31. Thus, by using the thermally expandable sheet 40 of the present embodiment, it is possible to cause the first thermally expansive layer 41 and the third thermally expansive layer 43 to distend and produce a shaped object 55 in which the base 31 is deformed, without using a heat conversion layer, which is typically required.

The present disclosure is not limited to the embodiments described above and various modifications and uses are possible. The embodiments described above can be combined as desired. For example, a configuration is possible in which, in Embodiment 2, the thermally expansive layer 21 is patterned and the mask 60 of Embodiment 1 is used to cause the electromagnetic waves to reach specific regions of the thermally expandable sheet. Additionally, Embodiment 2 and Embodiment 4 can be combined.

In Embodiment 4, an example of a configuration is given in which the first thermally expansive layer 41 and the third thermally expansive layer 43 are simultaneously caused to distend. However, the present disclosure is not limited thereto. A configuration is possible in which, first, one of the first thermally expansive layer 41 and the third thermally expansive layer 43 is caused to distend and, thereafter, the other of the first thermally expansive layer 41 and the third thermally expansive layer 43 is caused to distend.

In addition, in Embodiment 4 described above, an example of a configuration is described in which the electromagnetic waves are irradiated from the first side of the thermally expandable sheet 40. However, the present disclosure is not limited thereto and a configuration is possible in which a plurality of irradiation devices are used and the electromagnetic waves are simultaneously irradiated from the first side and the second side of the thermally expandable sheet 40. In this configuration, the first side and the second side of the thermally expandable sheet 40 can be irradiated with the electromagnetic waves from the various irradiators, and can be simultaneously irradiated by the electromagnetic waves. As a result, the first thermally expansive layer 41 and the third thermally expansive layer 43 can be collectively caused to distend.

The drawings used in the various embodiments are provided for the purpose of explaining the various embodiments. Accordingly, the thicknesses of the various layers of the thermally expandable sheets should not be construed as being limited to the ratios illustrated in the drawings.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A thermally expandable sheet, comprising:
a base; and
a first thermally expansive layer provided on at least a first side of the base and containing a first binder, a first thermally expandable material, and a first electromagnetic wave heat conversion material that converts electromagnetic waves into heat.

2. The thermally expandable sheet according to claim 1, wherein the first thermally expansive layer is patterned.

3. The thermally expandable sheet according to claim 1, wherein the first electromagnetic wave heat conversion material is cesium tungsten oxide or lanthanum hexaboride.

4. The thermally expandable sheet according to claim 1, further comprising:
a second thermally expansive layer containing a second binder, a second thermally expandable material, and a second electromagnetic wave heat conversion material that converts electromagnetic waves into heat, wherein
the second thermally expansive layer is provided on the first side of the base, in a different region than the first thermally expansive layer, or is provided by being laminated such that at least a portion of the second thermally expansive layer overlaps the first thermally expansive layer.

5. The thermally expandable sheet according to claim 4, wherein
the first thermally expansive layer containing the first electromagnetic wave heat conversion material at a first ratio with respect to a total weight of the first binder, the first thermally expandable material, and the first electromagnetic wave heat conversion material,
the second thermally expansive layer contains the second electromagnetic wave heat conversion material at a second ratio with respect to a total weight of the second binder, the second thermally expandable material, and the second electromagnetic wave heat conversion material, and
a value of the first ratio is different from a value of the second ratio.

6. The thermally expandable sheet according to claim 1, further comprising:
a third thermally expansive layer provided on a second side of the base and containing a third binder, a third thermally expandable material, and a third electromagnetic wave heat conversion material that converts electromagnetic waves into heat.

7. The thermally expandable sheet according to claim 1, wherein
the base is made from a thermoplastic resin, and
when the thermally expansive layer is distended, an amount of deformation (when the thermally expansive layer is distended) of the base is greater than a distension height of the thermally expansive layer.

8. A production method for a shaped object, comprising:
preparing a thermally expandable sheet including a base and a first thermally expansive layer provided on at least a first side of the base and containing a first binder, a first thermally expandable material, and a first electromagnetic wave heat conversion material that converts electromagnetic waves into heat; and
preparing a mask that includes an opening that corresponds to a region where the first thermally expansive layer is to be caused to distend, irradiating the first thermally expansive layer with electromagnetic waves via the mask, and causing the first thermally expansive layer to distend.

9. The production method for a shaped object according to claim 8, wherein
the base is made from a thermoplastic resin, and
the base is caused to deform in accordance with distension of the first thermally expansive layer.

10. The production method for a shaped object according to claim 9, wherein when the thermally expansive layer is distended, an amount of deformation (when the thermally expansive layer is distended) of the base is greater than a distension height of the thermally expansive layer.

11. The production method for a shaped object according to claim 8, wherein the first electromagnetic wave heat conversion material is cesium tungsten oxide or lanthanum hexaboride.

12. A production method for a shaped object, comprising:
preparing a thermally expandable sheet including
a base,
a first thermally expansive layer provided on at least a first side of the base and containing a first binder, a first thermally expandable material, and a first electromagnetic wave heat conversion material that converts electromagnetic waves into heat; and
a second thermally expandable sheet provided on at least the first side of the base and containing a second binder, a second thermally expandable material, and a second electromagnetic wave heat conversion material that converts electromagnetic waves into heat; and
irradiating the thermally expandable sheet with electromagnetic waves and causing the first thermally expansive layer and the second thermally expansive layer to distend.

13. The production method for a shaped object according to claim 12, wherein
the base is made from a thermoplastic resin, and
the base is caused to deform in accordance with distension of the first thermally expansive layer and distension of the second thermally expansive layer.

14. The production method for a shaped object according to claim 13, wherein when the thermally expansive layer is distended, an amount of deformation (when the thermally expansive layer is distended) of the base is greater than a distension height of the thermally expansive layer.

15. The production method for a shaped object according to claim 12, wherein the second thermally expansive layer is provided on the first side of the base, in a different region than the first thermally expansive layer, or is provided by being laminated such that at least a portion of the second thermally expansive layer overlaps the first thermally expansive layer.

16. The production method for a shaped object according to claim 12, wherein the first electromagnetic wave heat conversion material is cesium tungsten oxide or lanthanum hexaboride.
